(19) United States
(12) Patent Application Publication
(10) Pub. No.: US 2005/0137929 A1
(43) Pub. Date: Jun. 23, 2005

(54) Health unit assessment tool

(75) Inventors: Carmen V. Frazier, Eayle River, AK (US); John Epler, Evanston, IL (US)

Correspondence Address: MCANDREWS HELD & MALLOY, LTD, 500 WEST MADISON STREET, SUITE 3400, CHICAGO, IL, 60661, US

(73) Assignee: IBEX Healthdata Systems, Inc.

(21) Appl. No.: 10/866,313

(22) Filed: Jun. 10, 2004

Related U.S. Application Data
(60) Provisional application No. 60/478,215, filed on Jun. 13, 2003.

(51) Int. Cl. G06F 17/60

(52) U.S. Cl. 705/9

(57) ABSTRACT

The invention is a normalized scoring method and apparatus for the patient care departments of a health care facility having more than one scored patient care department. The scoring method can be used, for example, to direct additional resources to departments that are less well staffed or have fewer available beds or other patient receiving areas than other departments, relative to need. For each scored health care department, scores are preassigned to different numbers of available beds or other patient receiving areas and to different staffing levels in the department. Different departments are independently scored, so the same number of available workers or the same number of available beds may be preassigned different scores in two different departments. An overall score is independently determined for each health care department by adding the patient receiving areas component and the staffing level component, and optionally other factors.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates generally to a business management method and apparatus for assessing and reporting the utilization of resources in different patient care departments of a health care facility. The invention relates more particularly to the assessment of differences in the utilization of staff and of patient receiving areas (for example, hospital beds) in different patient care departments.

Hospitals and other health care facilities have recently had recurring problems in maintaining appropriate staffing levels and bed capacities to meet periods of high demand. Hospitals are used here as an example, but other health care facilities often face similar problems.

On the one hand, there is a persistent shortage of skilled health care workers, particularly registered nurses, to choose from, so it has become necessary to pay health care workers substantially higher wages or provide more flexible working conditions to retain an appropriate staff. Retaining a given number of qualified staff members costs more than it once did. On the other hand, as the patient population has aged on average, patients require ever increasing amounts of health care. The result is that hospital staffs are often lean, and the demand for hospital beds is increasing.

At the same time, the compensation to the hospital for providing health care services has been limited by medical reimbursers, including governments and insurance companies. As a result, hospitals have been required to become more efficient to survive. It is not easy, and often not possible, to staff a hospital so generously that periods of unusually high demand can be satisfied easily.

One particular problem in hospitals is that supply and demand fluctuates from hour to hour, spread unevenly among different departments of a hospital, often due at least originally to causes beyond the control of the hospital staff and management. If each department of a hospital is adequately staffed only for average conditions, periods of unusually high demand cannot be readily accommodated. Requiring the department staff to simply work harder can result in burnout or resignations, which aggravate the problem, as replacement staff must be trained.

Another problem in hospitals is that one care-giving department sometimes does not communicate in an adequate and timely manner with another care-giving department of the same facility. If one department has excess unused capacity (of beds, staff, or other resources) and another department is overstrained, the departments and management frequently are unaware of this until after the problem has developed. Once the problem develops, it frequently spreads within the hospital.

For example, assume an emergency department has a backlog of patients to be admitted to the hospital, but a particular department in the hospital to which the emergency department wants to transfer patients has a staff shortage or no beds available. While the patients cannot be admitted to the hospital, they add to the backlog in the emergency department, which itself may be unable to care for patients in its waiting room in a timely manner because it is still caring for the proposed transferees. The emergency department can find available beds in other departments that could admit and care for the patients only by a series of telephone calls to other departments or other cumbersome methods.

Similarly, if patients who have improved in intensive care are to be transferred to a less expensive department such as a medical/surgical floor, and the department proposed to receive the patient is unusually busy or understaffed, the patient may remain in intensive care too long, thus occupying a highly staffed intensive care bed that could better be used for a sicker patient.

Further, in a departmentalized hospital, each department has first-hand knowledge of its own needs and challenges, but much less appreciation for the needs and challenges of other departments to or from which patients can or should be transferred. When told that another department cannot receive a new patient, the department attempting to transfer the patient may not believe the representation of the complaining department that it does not have the resources to receive a new patient. The natural tendency is to act on the belief that the proposed receiving department is less efficient or diligent than one's own department. This can lead one's own department to experience stress that is blamed on the other department. The department perceived as being less efficient is also required to communicate extensively with all the other departments that are proposing to send them more work which they are not equipped to do. Staff members in an overtaxed department thus spend some of their scant resources on discussing or disputing the problem with other departments.

Hospitals attempt to provide floating resources to assist departments that have an unusual short-term need, but often it is difficult to determine where to provide the resources, when a problem in one department has led to corresponding problems elsewhere in the hospital. For these reasons, it is often difficult to shift resources so they are fully utilized without overtaxing one department or another.

### BRIEF SUMMARY OF THE INVENTION

The following definitions are used in this specification.

A “health care facility” is broadly defined as any place or set of places that provide health care of any kind to patients. A health care facility is not limited to one building or one organization. For example, several health care facilities can be located in one building or otherwise defined as one organization, or one health care facility can be located in several different buildings or otherwise defined as several different organizations.

One non-limiting example of a health care facility is a hospital. Another such example is a group of hospitals affiliated in some way, such as being located in the same city, or near each other, or being commonly owned or managed. Additional examples include a dental practice, a health maintenance organization, a hospice, an extended care facility, a physical therapy practice, or physician practice group. Additional examples will readily occur to the skilled person.

A “patient care department” is one of plural subsets of a health care facility that care for patients. Patient care departments commonly differ in the type of patients they care for or the type of care they provide to patients. “Patient care department” can also refer to a group of departments or a portion of a single department that is separately scored according to the present invention.

A “patient receiving area” is one bed of a hospital, a single examination table, one seat in the waiting room of an emergency room, the passenger area of an emergency medical technician vehicle, or some other unit of a patient care department in which a patient is waiting for or receiving care. An “available” patient receiving area is an area that does not currently have a patient and is not otherwise unusable (for example, because it needs cleaning or repair).

“Acuity” has its usual definition in the health care field, referring to how sick a patient is, or more precisely how closely the patient must be attended to. Acuity is scored for reporting purposes such that a high acuity patient has a higher acuity score. For present purposes, it suffices to state that a high acuity patient requires more staff attention than a low acuity patient.

One aspect of the invention is a normalized scoring method for the patient care departments of a health care facility having more than one scored patient care department. The scoring method can be used, for example, to direct additional resources to departments that are less well staffed or have fewer available patient receiving areas than other departments.

For each scored health care department, patient receiving area scores are pre-assigned to different numbers of available beds or other patient receiving areas in the department. The number of patient receiving areas available for receiving patients is also determined independently for each of the plural health care departments. An available-patient-receiving-areas component of a score for each said health care department is independently determined by assigning the appropriate predetermined score representing the number of available patient receiving areas.

For each scored health care department, staffing-level scores are pre-assigned to different numbers of available staff members in the department. The number of staff members available for servicing patients is determined independently for each of the plural health care departments. A staffing level component of a score for each health care department is independently determined by assigning the appropriate predetermined score representing the number of available staff members.

An overall score is independently determined for each health care department. The overall score is the sum of the patient receiving areas component and the staffing level component, and optionally also takes into account other factors.

Optionally, the scores calculated for each department can be presented on common displays available to several different scored departments, so all the affected departments know which departments are overtaxed and require additional resources. If a sending department can see that the proposed receiving department for a patient transfer is too busy, the sending department can immediately find another department on the common display to send the patient to, without a series of phone calls discussing the situation with the busy department and calling other departments to find a substitute. The busy department can spend more of its lean resources on patient care and fewer resources on negotiation with other departments. Hospital management can also have a display, so struggling units can be identified and floating resources or other help can be provided.

Optionally, the score can be transmitted to a manager, either routinely or when the score becomes worse.

Another aspect of the invention is a health care resource scoring apparatus for a health care facility having more than one department. The apparatus can be used, for example, for carrying out the previously described method. The apparatus generally includes a digital computer or other processor, sources of data reflecting how many beds or other patient receiving areas are available and the staffing level at a given time, scoring programming embodied and operating in the processor or elsewhere in a computer network, and a display for displaying scores determined by the apparatus.

The processor has an input to receive input data and an output for providing output data. Input data is provided reflecting how many patient receiving areas are available in each of plural health care departments. Additional input data is provided reflecting how many staff members are available to work in each of the plural health care departments.

Scoring programming operates in the processor. The scoring programming operates to independently determine, for each scored health care department, a first component of a score representing the number of available patient receiving areas, with more available patient receiving areas typically yielding a better score.

The scoring programming further determines from the number of available staff members in each department a second component of a score. The scoring programming independently determines a composite score independently for each of the scored health care departments. The composite score is the sum of at least the first and second components.

The apparatus includes a common display for displaying output data representing the scores of the respective scored health care departments together, so the scores of the departments can be compared and adjustments made to the staffing levels, number of available patient receiving areas, or other resources in different departments to react to the report of a poorer than desired score.

Other aspects of the present invention will become apparent upon review of the present specification and drawings.

### BRIEF DESCRIPTION OF THE SEVERAL VIEWS OF THE DRAWING

FIG. 1 shows the top screen of a unit assessment tool according to the present invention, showing the status of all covered departments of a hospital on one screen of a conventional computer.

FIG. 2 is a data entry screen accessed, for example, by drilling down from the screen of FIG. 1, on which the Intensive Care Unit (ICU) records its census, staffing, resources, and other statistics, from which the state of the department as shown in FIG. 1 is determined.

FIG. 3 is a view similar to FIG. 2, showing the data entry screen for a medical/surgical care department of a hospital, which has different scoring and collects different statistics than the data entry screen of FIG. 2.

FIG. 4 is an “All Stats” screen showing a number of different statistics for each department regarding census, number of open beds, staffing, and other issues selected for communication by each department.

FIG. 5 is an administrative screen demonstrating the assignment of points to one category of information requested in the data entry screen of one particular department.

FIG. 6 is a schematic view of apparatus for carrying out the present invention.

Like or similar items are indicated by the same reference characters in the respective views.

### DETAILED DESCRIPTION OF THE INVENTION

While the invention will be described in connection with one or more embodiments, it will be understood that the invention is not limited to those embodiments. On the contrary, the invention includes all alternatives, modifications, and equivalents as may be included within the spirit and scope of the appended claims.

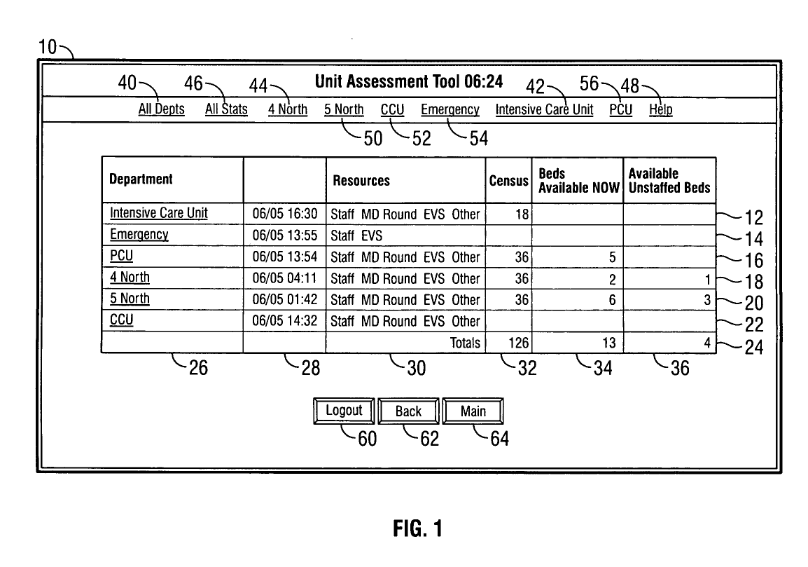

FIG. 1 is a view of the top screen 10 of a unit assessment tool according to the present invention, showing the status of all covered departments of a hospital on one screen of a conventional computer. In this embodiment, the screen 10 includes a data row 12 showing the status of the Intensive Care Unit (ICU), a data row 14 showing the status of the Emergency Care Unit (ECU), a data row 16 showing the status of the Post-Critical Care Unit (PCU), a data row 18 showing the status of a first medical/surgical care unit located on the north end of the fourth floor of the hospital, a data row 20 showing the status of a second medical/surgical care unit located on the north end of the fifth floor of the hospital, a data row 22 showing the status of the Critical Care Unit (CCU), and a total row 24 summing the statistics for all the listed departments of the hospital.

The screen 10 is further subdivided into a department column 26, a time column 28, a Resources column 30, a Census column 32, a Beds Available column 34, and an Available Unstaffed Beds column 36.

The department column 26 identifies each reported department. The time column 28 shows the last time the reported statistics were updated.

The Resources column 30 allows a department to request assistance of the listed types of personnel, here selected from Staff (i.e. nurses), MD Round (i.e. physicians), EVS (Environmental Services—the personnel who clean and sanitize patient receiving areas and common areas), and Other, for categories of personnel less-frequently or less-critically required. The resources for each department can be the same or different. For example, the Emergency Care Unit does not have “MD Rounds” or “Other” listed in this embodiment, while the other departments do.

The Census column 32 reports the number of patients in each department. The Beds Available Now column 34 reports how many beds in a given department are empty and are available for immediate occupancy, which represents that patients can be transferred to the department. The Available Unstaffed Beds column indicates that the beds themselves are empty and available for immediate occupancy, but the staff of the department is currently insufficient to allow the beds to be used.

In this embodiment, part or all of each row such as 12 can be shaded to represent the score (i.e. need for additional resources) of the department represented by that row. While a variety of different color schemes can be used, it is convenient to use the red, yellow, and green colors of a traffic stoplight, which are essentially universally recognized.

In one embodiment, green represents that the department is running well and has no problems requiring the attention of management or forbearance by other departments in transferring patients to the department as appropriate. Yellow represents caution, and indicates that the department is functioning adequately, but has more than the optimum number of patients, less than full staffing, or some other problem indicating that the department is on its way to having a problem. Red indicates that the department is sufficiently understaffed that it is closed to new patients, so it is critical that its condition be reversed as soon as possible.

Additional colors can also be employed to indicate an intermediate state. For example, in one embodiment it is useful to have an additional color between yellow and red indicating that the department has a serious problem but is not closed altogether. Orange, which is widely recognized as the result of combining red and yellow pigments, can be used as the intermediate color.

Naturally, there is no limit on the number of colors that could be employed to show different levels of need, and a different color scheme can be employed, but it is convenient to have three or four colors, three of which are red, yellow, and green, to show the status of a department in a widely recognized, simple format.

In the embodiment of FIG. 1, the background of the row 12 for the Intensive Care Unit could be shaded red to indicate that this department is closed to new patients and having difficulty caring for the patients it already has. Row 14 could be shaded orange to indicate that it is doing better than Intensive Care, but still has an urgent need for resources. Rows 16, 18, and 20 could be shaded green to indicate that they are running well and have both available beds and the staff to care for patients transferred to at least some of these beds. Row 22 for CCU has no entries for available beds, but has no census. This row has dropped to the bottom of the chart because CCU is not using the Unit Assessment Tool. This illustrates that some departments may choose not to use the tool, or may be tracked separately from other departments, for example.

In the illustrated embodiment, an identical top-level screen 10 is on display in each of the listed departments, so anyone in any of the covered departments can see the status of their own department and fellow departments at a glance. The top-level screen 10 can be made available as well to nearby and/or remote managers, as appropriate. The screen is so simple that the status of a large number of departments in a hospital, or even a large number of hospitals in a network, each occupying one line item, can be shown in a way that can be reviewed and understood at a glance.

In the illustrated embodiment the rows of the display are sorted by order of score, so the department having the poorest score is shown as the top entry and the department having the best score is shown as the bottom entry. This view is thus well suited to allow Management to see at a glance which of its departments is at the head of the list, and thus must be attended to immediately, as this unit is turning away any and all new or transferred patients. For example, in FIG. 1 the Intensive Care Unit is the top-listed unit, and could be shaded red. Patients who need to go to the Intensive Care Unit must be turned away, and may need to go to another hospital immediately if they are too sick to remain in a less highly staffed department.

A view ranked by the need for additional resources is also useful to the individual departments who need to know where they can transfer a patient needing a different level or type of care to a more appropriate department. For example, an intensive care patient who has improved may need to be transferred to a medical/surgical care department, to free up the intensive care resources. Since the units are ranked from worst to best, a particular unit can find all the units that are prepared to accept patients by looking at the entries from the bottom of the list first, and moving up the list until an appropriate receiving department is found.

The usual previous way of finding an open bed in this situation was to call one or more medical/surgical care departments until one was reached that was available to answer the telephone and would indicate willingness to accept patients. A department that answered the phone diligently would fill up, while a department that was difficult to reach would be less in demand, so the departments had a motivation to ignore phone calls from other departments.

Alternatively, the list can be sorted by any other criteria. For some situations, a list that always has the departments in the same order may be useful. For example, the display can be a map of the hospital, with the departments organized by location within a hospital. Another possibility is to list interchangeable departments, like several different medical/surgical care units, in one area of the display, but ordered according to score, so the least busy unit of a kind can easily be identified and a patient can be transferred there. Thus, one part of the display can be organized by need for resources, while another part of the display can be organized in some other manner. The present disclosure in its broadest aspect is not limited according to the organization or layout of the display.

While in this embodiment not all the departments of the hospital are using the tool, alternatively all the departments of one hospital, or departments in more than one hospital, or multiple hospitals in the same vicinity, or other combinations of departments can be shown. Alternatively, the display can be used to represent multiple subunits of one department of the hospital. The present disclosure in its broadest aspect is not limited according to the selection of which departments are or are not tracked on the display.

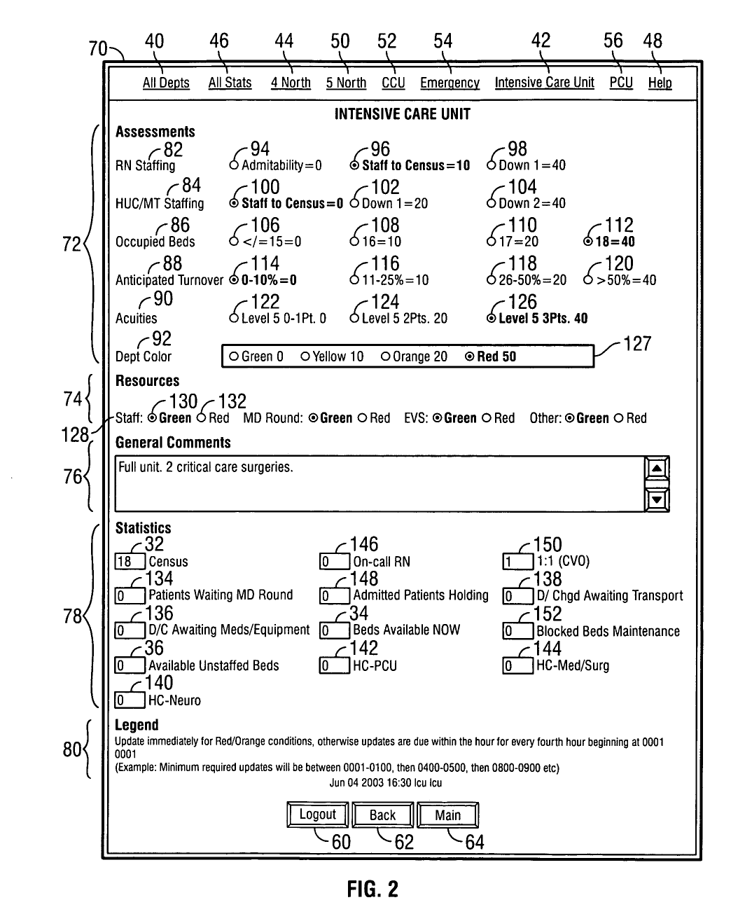

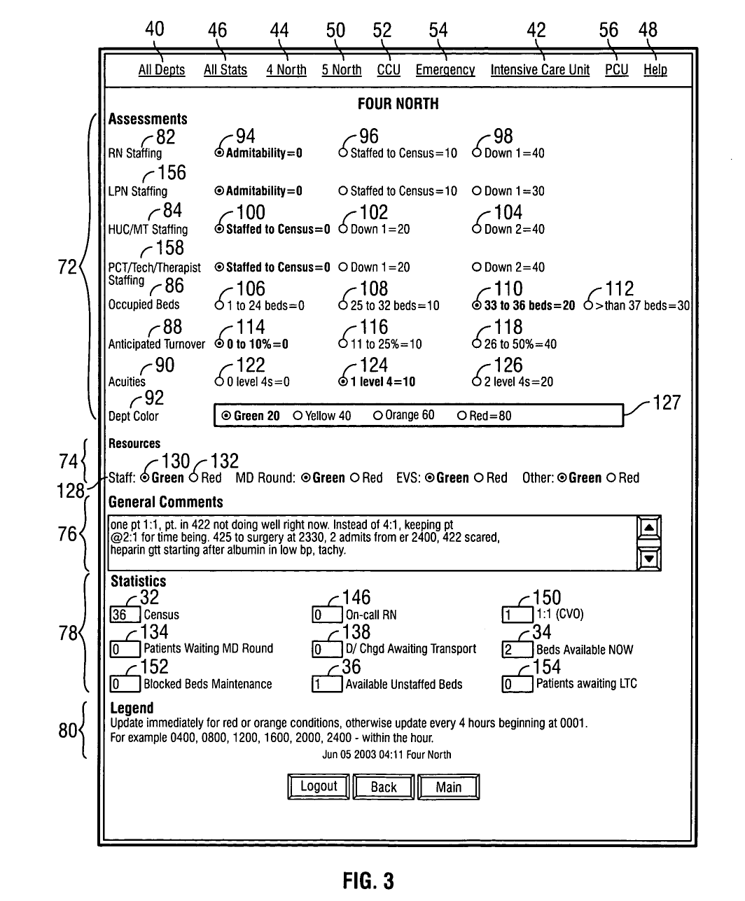

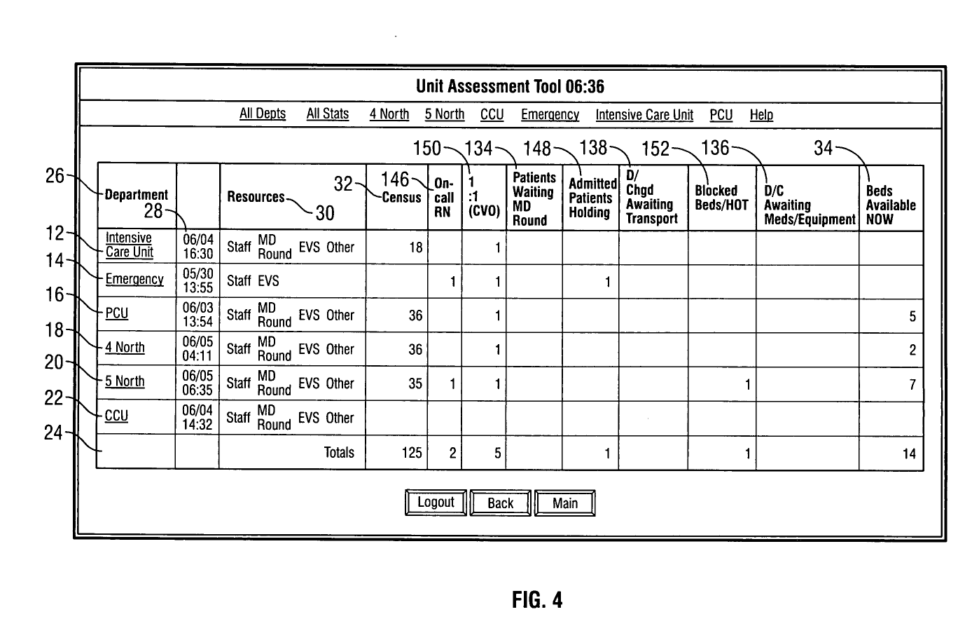

Returning to FIG. 1, in this embodiment the top screen has several links to related screens. The “All Depts” link 40 returns the user from other screens to the top screen shown in FIG. 1. The “Intensive Care Unit” link 42 and the “4 North” link 44 (4 North is a medical/surgical care ward in this example) call up detail screens for those individual departments, as shown in FIGS. 2 and 3, respectively. The “All Stats” link 46 calls up a detail screen, illustrated by FIG. 4, showing more detailed statistics for each department regarding census, number of open beds, staffing, and other facts selected for communication by each department. The “Help” link 48 calls up information about the definitions of the colors on the display, definitions of terminology, and other matters useful to users of the system. The other links in the display of FIG. 1 are the 5 North (another medical/surgical care unit) link 50, the “CCU” (Critical Care Unit) link 52, the Emergency (Emergency Care Unit) link 54, and the “PCU” (post-critical unit, a unit typically used for heart patients who are not sick enough to require intensive or critical care, but do require cardiac monitoring) link 56.

The buttons 60, 62, and 64 are provided to enable the user to logout, to go back to the preceding screen displayed, or to link to the Main screen, respectively. The Main screen is the top screen of the Unit Assessment Tool in this embodiment.

FIG. 2 is a drill-down data entry screen entered from the screen of FIG. 1 by using the Intensive Care Unit (ICU) link 42. FIG. 2 shows the web page or other display on which the ICU records its census, staffing, resources, and other statistics, and from which the state of the ICU department as shown in FIG. 1 is determined and displayed in more detail. Referring now to FIG. 2, the data entry screen 70 has the same links 40-56 and buttons 60-64 found in FIG. 1. The screen 70 has five main areas: the Assessments field 72, the Resources field 74, the Comments field 76, the Statistics field 78, and the Legend field 80.

The Assessments field 72 allows the user to score the department and determine the color shown in the top-level screen (in this case, red) by answering five short, factual, multiple-choice questions (one per row in FIG. 2). Answering the question presented in the row 82 indicates the status of RN staffing. Answering the question presented in the row 84 indicates the status of HUC/MT Staffing. Answering the question presented in the row 86 indicates the number of Occupied Beds. Answering the question presented in the row 88 indicates the proportion of Anticipated Turnover in the department in the next time interval, such as the next shift or the next hour. Answering the question presented in the row 90 indicates Acuities—how many particularly sick patients requiring extra care are in the department at a given time.

In the “RN Staffing” row 82, the user is requested to objectively classify the adequacy of the department's RN staff to meet its present needs. The user's first option is to report “admitability” (i.e. the unit has enough RNs presently working in the department to adequately service additional patients, while maintaining the desired staff to census ratio), leading to the lowest possible score of 0 in this instance, by clicking on the “admitability” option 94. A manager, as explained later in this specification, predetermines the score of “0” assigned to a report of admitability. Reporting admitability may indicate a staff so large, in relation to need, as to be inefficient, so a manager trying to move staff to an overtaxed department can consider moving a staff member from a department showing admitability if needed, depending on the overall score. Persistent admitability indicates that perhaps the nominal staff level in the department can be reduced.

The second RN staffing option to report, which is selected here, is “staff to census” (i.e. the unit has exactly enough RNs to adequately service the patients it has, but no additional resources to service any new patients while maintaining the intended staff to census ratio). This option is selected by clicking on the option 96 (Staff to Census). This situation has been assigned a predetermined score of 10 points. The department having this score may be running well, but it has no capacity to accept new patients while maintaining the desired staff to census ratio. This is an early warning that the department will be significantly understaffed if even one staff member must leave for some reason or one more patients enter. Thus, this score alone will change the green department color to yellow, even if all other factors remain optimal. Again, the specific point value has been customized to the operation of that department.

The third RN staffing option to report in this example is “down 1,” indicated by selecting the option 98, meaning that the staff presently working has one too few RNs to maintain the intended staff to census ratio at present. This is a serious situation that must be corrected immediately if possible, leading to an orange status color for the department by itself. The status color would be red in this example if even one other factor in the assessments field is less than optimal. While additional options indicating a still greater crisis could be provided, in this example they are not, as an assessment has been made that action must be taken immediately to help this understaffed department, such as by transferring an RN from elsewhere or providing a floating or temporary help RN.

In the illustrated embodiment the scoring for the RN staffing factor (and other factors) is not linear. For example, admitability is scored 0, staff to census is scored 10, while “down 1” is scored 40. These factors are predetermined by some person who is familiar enough with the department and its operation to know what weight to give to different situations in the department. A linear scale may also be used, as another option, although a scale such as this one that gives any under capacity much more weight than the absence of overcapacity is likely to be best for a staffing evaluation because of the importance of staffing to census and being able to maintain that status despite an influx of new admissions.

The next row in the Assessments field 72 is “HUC/MT Staffing,” in Row 84. The scoring is carried out in the same manner, but for this class of staff members the scoring is different.

“HUC” stands for “health unit coordinator,” which is a largely clerical person able to effectively operate a computer terminal for input and retrieval of patient data. An HUC commonly assembles patient records, imprints forms, graphs or charts information onto appropriate forms, answers phones, delivers messages to unit personnel, signs off Doctors' orders, prepares consent forms, and may also have limited patient contact such as distributing menus, flowers, mail and messages to the patient. They may order patient daily diets, order daily lab studies, process patient admissions, transfers and discharges.

“MT” stands for Monitor Technician, and is a staff member who takes care of all the patient monitors in use, which is considered a patient care function but largely involves maintaining the equipment.

In this department, an assessment has been made that staffing HUC/MT staff to census is optimal performance, and thus does not call for an assessment of points, as does staffing RNs only to census. Also, MTs and HUCs are assessed as a single unit, not separately. They could be scored separately, but an assessment has been made in this department that this shortcut does not impair the information obtained enough to be a problem. This could reflect a degree of functional interchangeability of these positions with each other, or between departments in the hospital, or that there are more of these categories of staff members so one of each can be missed without shutting down the department, or that these types of staff members can defer some of their duties if the department is shorthanded.

Further, the HUC/MT staffing question has a greater range on the right end, since it allows a response that as many as two HUC/MT staff members are missing. Down two HUC/MT staff members below census has been determined in this situation to be about equal to one RN down. Note also that the scoring for HUC/MT staffing is linear in this instance, with each missing staff member (whether one or two are missing) counting 20 points.

The “Occupied Beds” question 86 (which can be generalized as the number of occupied treatment areas) is straightforward, and calls for the census of the department to be reported as less than or equal to 15 beds (option 106), 16 beds (option 108), 17 beds (option 110) or 18 beds (option 112). This may be an 18-bed department, since the highest available report is 18 occupied beds and the point score goes up rapidly as the last open beds in the department are occupied. No management attention is needed to address an excess number of beds on a short-term basis, such as from hour to hour. But as the last beds fill up the score goes up radically, motivating corrective action by management.

The “anticipated turnover” question 88 is important because turnover by discharge of some patients increases the amount of work in the department on a per-bed basis. If a patient is in the department for just one day, the same admission, discharge, and/or transfer procedure needs to be followed for that patient as for a patient who is in the department for a week. Thus, the more turnover (defined as a percentage of the beds in the department) expected in a fixed period of time, the more work staff members at all levels must do. This is an example of information that is not captured by measuring how many beds are occupied, since the amount of work depends on how many times the occupant changes, not how many occupants there are. The predetermined responses are 0-10% (option 114), 11-25% (option 116), 26-50% (option 118) and greater than 50% (option 120). Here more (four) different options are provided, and the scores rise relatively slowly until turnover is at the highest reportable level of over 50%.

The acuities question 90 calls for the user to report how many high acuity (i.e. level-five-acuity) patients are being cared for. This standardized measure of how sick is the patient determines to a large degree how much staff attention the patient requires. If a department has many high acuity patients, the same staff has more work to do, thus spreading its resources more thinly. This is somewhat similar to anticipated turnover, as it is another indication that the same number of beds represents more work in some instances. This is information that a pure bed-counting system cannot capture. The indicated choices in this instance are the options 122 (no or one level-five-acuity patient), 124 (two level-five-acuity patients), and 126 (three level-five-acuity patients).

The points assigned according to the answers to the five questions in the Assessments Field 72 are added up to provide an overall department score, which is then compared to the color definitions in the Dept Color row 92 to select a background color for the department on the top screen (FIG. 1) and to prioritize the listing of departments on the top screen, with high-scoring departments appearing first in this embodiment. Since all five questions are readily answerable by a charge nurse or management relying on standard reports (except for anticipated turnover, which is a forecast and would normally require management expertise in the department), these questions can be answered accurately and quickly by the department, or automatically by a query to the electronic medical and other records maintained by the hospital or other health care organization by the Unit Assessment Tool software.

The assessment may take into account other questions not shown here or not account for all of the types of questions shown here, within the broad scope of the invention. The overall scoring will generally be carried out by adding individual scores. For the purposes of the present invention, addition of scores also includes a situation in which the scores are subtracted from an optimal value, as subtraction is mathematically the same thing as adding negative numbers.

As one option, the department color calculated (usually) by a local or Web-connected microprocessor is displayed in the Department Color box. The calculated color may also optionally be used as the background color for the single-department display of FIG. 2, so the department itself is aware of its own status at all times. In the Example of FIG. 2, the overall calculated score is over 50, which is scored as red, due to staffing only to census (10 pts.), a completely full department with all beds occupied (40 pts.), and the presence of three acuity-level-five patients (40 pts.), for a total score of 90 pts. This is a department that desperately needs more resources, even though a bed tracking system would show that the beds are currently full but staffed to census. This result reflects the fact that this is the assessment for an intensive care unit, which carries out functions other departments, such as medical/surgical care, are not equipped to deliver for very ill patients, with no elective admissions.

As another option, the user may be given the option of changing the Department Color from the nominal color assigned by rote calculation. This option is useful to allow the user to report that, while the department is presently poorly equipped, an improvement is expected soon that will resolve the shortage. For example, if the user filling out the report knows that staff is down by 1, because an RN is late for work, but the RN has called and will be present in 10 minutes, an election may be made to improve the color scoring to avoid raising an alarm when the situation will be resolved in 10 minutes without requiring management attention. Alternatively, the user may be given the option to degrade the calculated score if the situation is expected to worsen shortly. A news report of a large accident in the vicinity of the hospital, with many victims, may cause the emergency room staff to downgrade its readiness, even though the new influx of patients, expected soon, has not yet occurred.

The power to re-define the calculated department status can be granted to a limited class of individuals, or be accompanied by a duty to report in more detail more information about the situation explaining the change of status. The system can be set up to require confirmation by a second user of a change of status proposed by the first or usual user of the system. The system can be designed to permit a change of status by one category, as from orange to yellow, while prohibiting larger changes of status. The system can be set up to record the instances and data frequently leading to re-definition of the overall score, so management attention can be given to whether the scoring is being done accurately, or whether the point weights given to different situations reasonably reflect the state of the department.

Continuing with FIG. 2, the Resources field 74 allows the department to display additional information respecting staffing in the department in a different format that does not directly enter into the assessment score. The “Staff” query 128 allows the department to report the staffing levels generally as “green” (option 130), indicating adequate staffing, or “red” (option 132) indicating inadequate staff. This then provides a non-verbal comment, based on a red or green display in the Resources section 30 of FIG. 1.

The Comments field 76 also shown in FIG. 2 is a free text area allowing the user to make appropriate comments explaining the status of the department or specific resources, like the attention of a particular doctor required by a particular patient. These comments may reinforce or supplement the scoring information. If a particular comment is made frequently in a particular department or relied upon heavily, the comment can also be considered for inclusion in the statistics field 78, described below.

The Statistics field 78 in FIG. 2 provides more detailed communication by a department of what resources it needs to do its job better. Some of the statistics, like Census (box 32), Beds Available Now (box 34), and Available Unstaffed Beds (box 36), are of general interest in other departments and frequently of interest to managers, and are thus reported directly in the top level screen shown in FIG. 1. Other statistics may be reported for various purposes. One possible reporting item is the number of patients awaiting physician rounds (box 134). Another reportable statistic in this example is the number of patients who are discharged but need information, equipment, a prescription, or transport services before they can vacate their beds (boxes 136 and 138). These beds can readily be freed up by doing something, and this screen can be used to report the hold-up to those who can act to alleviate the problem.

Another category of reportable statistics reportable by an intensive care unit is the number of “house convenience” or HC patients in various areas. In FIG. 2, the three types of HC patients are the number of HC patients who could be moved to a neurological unit (box 140), a post-critical care unit (box 142), and or a general or medical/surgical unit (box 144). These are patients whose condition has improved to the point that they can be moved from the high-cost intensive care unit to a lower-level care unit like a neurological, post-critical care, or surgical unit, thus freeing up the more expensively staffed and equipped intensive care beds for incoming patients that require them while still giving appropriate care to improved patients. This area can be examined to improve the efficiency of a hospital, which may not fully recover the additional costs of intensive care over a medical/surgical care unit.

Additional statistics that can be reported in the embodiment of FIG. 2 include whether the department has access to an on-call RN (box 146), which perhaps another department can borrow if the lending department has no need for another RN on a given shift; or admitted patients holding (box 148), which indicates patients that are admitted to the department but not yet assigned to beds—a situation which should be addressed right away. Still other situations that can be reported include the following. Box 150 allows reporting of 1:1 Constant-Vigilance Orders (CVOs)—orders by the attending physician that an RN is to be present watching the patient at all times. This order will prevent the attending staff member from attending to any other patient, so it reduces the capacity of the department to staff the number of beds it has with a nominally sufficient staff. Box 152 provides a way to convey that the department has blocked beds that are unavailable for patient use due to a maintenance issue.

The Legend field 80 shown in FIG. 2 provides instructions to the user on how and when to update the system. Emphasis is placed on updating the system very quickly when the status of the department has deteriorated beyond a predetermined point, such as the orange level (i.e. 20 points or more), while the system can be updated less frequently when the status of a department is relatively constant and good.

FIG. 3 is a view similar to FIG. 2, showing the data entry screen for a general medical/surgical care department of the hospital (4 North), which has different scoring in several cases and collects different statistics from those in the data entry screen of FIG. 2. Some specific differences between FIGS. 2 and 3 are the following. FIG. 3 shows that 4 North has more kinds of employees participating in scoring than the Intensive Care Unit. Specifically, in FIG. 3 LPN (licensed practical nurse) staffing is scored in row 156, and PCT/Tech/Therapist workers are scored in row 158.

A Patient Care Technician (PCT) is supervised by a registered nurse and functions as a direct caregiver and member of the patient care team. A PCT assists patients with activities of daily living, monitoring vital signs, applying respiratory therapy equipment, collecting specimens, maintaining skin integrity through application of soaks, simple dressing changes, colostomy, ileostomy and decubitus care, removing Foley catheters and peripheral I.V.s, performing EKG's; application of Dynamap and pulse oximetry, obtaining capillary blood glucose results, etc.

A Therapist is a physical therapist. Again, PCTs, Techs, and Therapists are scored together in this instance, though they could alternatively be scored separately.

Referring to the occupied beds row 86, FIG. 3 shows that 4 North has more beds than the Intensive Care Unit of FIG. 2, so naturally more beds must be occupied to yield a given score. Also, even if 4 North is full, with more than 37 beds occupied, the score is lower than if intensive care is full, and the beds aren't counted one at a time as the department is nearly full. Going to anticipated turnover reported in row 88, 4 North in FIG. 3 scores a particular turnover more highly than does the intensive care unit in FIG. 2, which may be a different management scoring decision, or may reflect that Intensive Care often transfers a patient to another unit after the patient improves, rather than discharging the patient, and discharging requires more staff time than transferring.

The scoring of acuities, in row 90 is different for 4 North, as shown in FIG. 3, versus ICU, shown in FIG. 2. 4 North does not have acuity-five patients, who belong in ICU, so 4 North scores the number of acuity-four patients that are its sickest patients.

Some different statistics are reported for the respective departments. Boxes 136 (D/C Awaiting Meds/Equipment); 140, 142, and 144 (HC patients); and 148 (Admitted patients holding), all reported by the Intensive Care Unit in FIG. 2, are not reported by 4 North. FIG. 3 shows, however, that 4 North reports the number of patients awaiting LTC (Long-Term Care) in box 154, which has no counterpart in the Intensive Care Unit screen.

Also, the statistics reported in FIGS. 2 and 3 are listed in different order, reflecting different priority in these respective departments and showing the flexibility of the program. Further, the scoring for 4 North in FIG. 3 requires more points for a given color (for example 80 for red) than does the scoring for the Intensive Care Unit in FIG. 2 (50 is red). This is an example of normalizing the scores of two different departments, calculated on a different basis respecting different types of staffs and different weighting for the relevant factors. This normalization assures that a red background for 4 North carries the same weight, in terms of management attention and concern by other departments, as a red background for the Intensive Care Unit.

FIG. 4 is an “All Stats” screen showing the statistics for every tracked department on a common display in more detail than is provided in the top screen, but less detail than is shown in department screens like FIGS. 2 and 3. The statistics in FIG. 4 are all reported in the Intensive Care Unit statistics field 78, and are reformatted to produce FIG. 4 so all departments have a uniform entry row. This screen tells staff that service more than one department, like transporters, physicians making rounds, maintenance workers, Environmental Services, etc., where they are needed most urgently, allows departments to attempt to borrow resources such as on-call RNs from departments that don't need them, and advises the number of beds immediately available, among other things. This view is hospital-wide and can be color-coded in the same manner as FIG. 1.

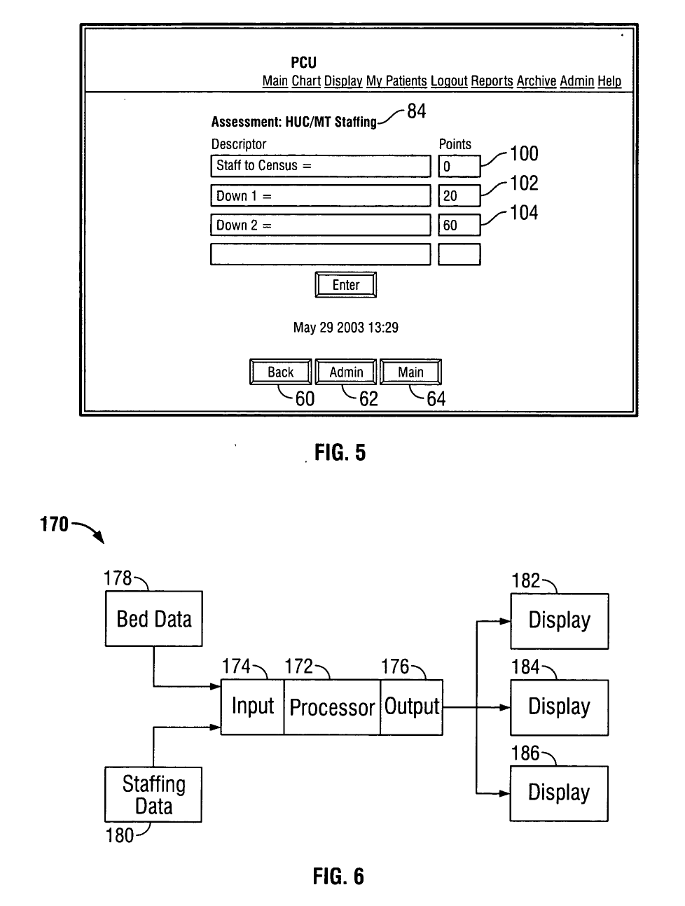

FIG. 5 is an administrative screen demonstrating the assignment of points to one category of information requested in the data entry screen of one particular department. Access to this screen may be limited to management or a senior person in the department, so the departments can enter statistics but cannot give undue weight to some factors over others, to a different degree than desired by management. New assessment items can be set up, point assignments can be changed, additional responses (like Down 3=100) can be provided, the order of statistics can be changed, and so forth.

A computer or other processor, alternatively including Internet communication apparatus, can be used to carry out this invention, in one embodiment. For example, FIG. 6 shows a health care resource scoring apparatus 170 for a health care facility having more than one department. The apparatus 170 comprises a digital processor 172 having an input 174 to receive input data and an output 176 for providing output data. The apparatus includes a first source of 178 of processor input data reflecting how many patient receiving areas (for example beds) are available in each of plural health care departments. The apparatus also includes a second source 180 of processor input data reflecting how many staff members are available to work in each of the health care departments.

The digital processor can take various forms. It can be provided in the form of a microprocessor, for example.

Similarly, the input can be as simple as a keyboard on which a person knowledgeable about the occupancy of beds in a department types the number of available beds or the number of occupied beds. Another useful input is a pointing device, such as a mouse or touchpad used to mark selected items on a monitor. Many different inputs can be arranged within the ordinary skill in the art, such as a voice recognition system programmed to perceive and make use of a spoken number indicating the number of available or occupied beds. The input can be data transferred to the processor 172 or generated by the processor 172 reflecting patient admitting or transfer information, employee time records (to see which employees in a given department “punched in” to the time recording system or key card system, or are logged in to computers or other equipment, or are otherwise identifiable as being present and working in a department. Employee schedule data can also be used as an input reflecting what employees are expected to be present. Employee sick call data can be used to indicate what employees scheduled to be working are not present.

In other words, data from various sources collected and used in a hospital or other medical or long term care facility can be used as input data allowing the calculation of a score reflecting the number of available staff members and the number of available beds in a given department at a given time.

The output can be any type of signaling, communication, or display device. For several examples, the output can be the monitor of a personal computer, a dedicated wall-mounted public display analogous to a bed board, a display on a personal digital assistant (PDA), a computer generated message communicated to a pager, cell phone, e-mail, or other forms of communication, an announcement on a public address system in plain or coded format, a printed message, a facsimile message, or others. For example, one presently contemplated system will automatically send a message to a pager, cell phone, or handheld unit for wireless receipt of email carried by one or more pertinent managers or staff members when the calculated score of the department reaches orange or red status. Optionally the message can be repeated at intervals if the status of the department continues to present a high score, or a follow-up message can be sent out when the department operation has improved to the extent that the score is yellow or better.

The processor includes a program that calculates independently for each of plural health care departments, from the number of available beds or other patient receiving areas, a first component of a score, with more available patient receiving areas yielding a better score. Referring again to FIG. 6, the source 178 of bed data can provide bed data independently for several units of a hospital, and the processor 172 can separately process the data and calculate an independent first component for each unit. The program can be located in a personal or mainframe computer on premises, or the program can be resident in a remote machine accessed via a modem and communication line or otherwise. The data can be affirmative data reflecting the number of available beds directly, or negative data reflecting the number of occupied beds, which can be subtracted from the total number of beds to yield the same information.

The processor includes a program that calculates independently for each of plural health care departments, from the number of available staff members, either generally or by function, a second component of a score, with more available staff members yielding a better score. Referring again to FIG. 6, the source 180 of staffing data can provide staffing data independently for several units of a hospital, and the processor 172 can separately process the data and calculate an independent second component of the score for each unit. Again, the program can be located in a personal or mainframe computer on premises, or the program can be resident in a remote machine accessed via a modem and communication line or otherwise. The staffing data can be either affirmative data reflecting the number of staff members present (which can be compared with the number of staff members needed to determine the adequacy of staffing), or negative data reflecting the number of staff members absent.

The first and second components of the score are added independently for each of the health care departments, determining a score for the health care department that is the sum of at least the first and second components of the score. Since the scoring can be more complicated, other factors can also enter into the calculation of the score, such as the number of high acuity patients, the experience level of the staff, factors indicating the probability that additional patients will be presented for admission at a given time of the day or week, etc. “Sum” is broadly defined here to include calculations making use of subtraction, as well as addition.

In this embodiment, the calculated scores for plural departments are displayed identically on several common displays 182, 184, and 186 which can be located in the respective departments, in the offices or other workspaces of managers, or the like. Displaying the parallel information for the respective health care departments in each of the affected health care departments provides a communication function that allows all viewers to have simply displayed, essential information about the status from time to time of each monitored department.

One particular advantage of the present method and system over a conventional system based on a bed board for determining where a hospital has available beds is that the present system can be used to present anonymous data. For example, it does not need to identify particular patients as high acuity patients, or name the patients in particular beds, as a bed board commonly does. The system tracks the numbers of available beds and staffing levels without naming any individuals. Similarly, staffing levels are tracked without identifying a particular staff member as present or absent, and without naming any staff member.

1. A normalized scoring method for a plurality of patient care departments of a health care facility, comprising:
a. predetermining independently for each of plural health care departments what available patient receiving area scores to assign to different numbers of available patient receiving areas in a department;
b. determining how many patient receiving areas are available to receive patients in each of the plural health care departments;
c. determining from the number of available patient receiving areas and the predetermined available patient receiving area scores for each department an available patient-receiving-area component of a score for each said health care department;
d. predetermining for each of plural health care departments what scores to assign to different levels of staffing in the departments;
e. determining the level of staffing in each said health care department;
f. determining from the level of staffing and the predetermined staffing scores for each department a staffing level component of a score for each said health care department;
g. determining a score for each said health care department that is the sum of at least said available patient receiving areas component and said staffing level component; and
h. transmitting said score to a manager.

2. The method of claim 1, wherein said score is transmitted to a pager carried by the manager.

3. The method of claim 1, wherein said score is transmitted to the manager via e-mail.

4. The method of claim 1, wherein said score is transmitted to the manager via wireless communication.

5. The method of claim 1, further comprising transmitting said score to a manager when the score changes in a predetermined manner.

6. The method of claim 1, further comprising transmitting said score to a manager when the score degrades beyond an alarm threshold.

7. A normalized scoring method for a plurality of patient care departments of a health care facility, comprising:
a. predetermining independently for each of plural health care departments what available patient receiving area scores to assign to different numbers of available patient receiving areas in a department;
b. determining how many patient receiving areas are available to receive patients in each of the plural health care departments;
c. determining from the number of available patient receiving areas and the predetermined available patient receiving area scores for each department an available patient-receiving-area component of a score for each said health care department;
d. predetermining independently for each of plural health care departments what scores to assign to different levels of staffing in a department;
e. determining the level of staffing in each said health care department;
f. determining from the level of staffing and the predetermined staffing scores for each department a staffing level component of a score for each said health care department; and
g. determining a score for each said health care department that is the sum of at least said available patient receiving areas component and said staffing level component.

8. The method of claim 7, wherein, for at least one said department, the predetermination of the score to assign to each staffing level, the determination of the staffing level, and the determination of the staffing level component of said score are carried out independently to determine separate scores for at least two different types of staff members, and the sum of the separate scores is said second component of the score.

9. The method of claim 8, wherein the number of physicians available is scored separately.

10. The method of claim 8, wherein the number of registered nurses available is scored separately.

11. The method of claim 8, wherein the number of licensed practical nurses available is scored separately.

12. The method of claim 8, wherein the number of patient care technicians available is scored separately.

13. The method of claim 8, wherein the number of health unit coordinators available is scored separately.

14. The method of claim 8, wherein the number of monitor technicians available is scored separately.

15. The method of claim 8, wherein the aggregate number of health unit coordinators and monitor technicians available is scored separately.

16. The method of claim 7, further comprising the steps of:
a. determining the estimated percentage of turnover the health care department will experience in a time interval;
b. determining from the estimated percentage of turnover a third component of a score, with a smaller expected turnover yielding a better score; and
c. determining a score for said health care department that is the sum of at least said first, second, and third components.

17. The method of claim 7, further comprising the steps of:
a. determining the number of high-acuity patients;
b. determining from the number of high-acuity patients a high-acuity-patient component of a score; and
c. determining a score for said health care department that is the sum of at least said available patient receiving areas component, said staffing level component, and said high-acuity-patient component.

18. The method of claim 7, further comprising displaying said scores in the form of a range of colors, from green for a predetermined best score to red for a predetermined worst score.

19. The method of claim 7, further comprising the step of revising a department's displayed score to deviate from its determined score, at the election of personnel in the department.

20. The method of claim 7, further comprising displaying said scores for each said health care department on at least one common display.

21. The method of claim 20, further comprising disposing a plurality of said common displays in plural health care departments.

22. The method of claim 7, wherein at least one said health care department has plural categories of patient receiving areas for different purposes, further comprising:
a. determining separately for plural categories of patient receiving areas how many patient receiving areas of each category are available for new patients;
b. determining from the number of available patient receiving areas in each of said plural categories a first component of a score for each of said plural categories;
c. determining how many staff members are available for each of said plural categories of patient receiving areas;
d. determining from the number of available staff members a second component of said score for each of said plural categories of patient receiving areas; and
e. determining a score for each of said plural categories of patient receiving areas in said health care department that is the sum of at least said first and second components.

23. The method of claim 22, further comprising displaying the scores for said plural categories of patient receiving areas on a common display.

24. The method of claim 7, wherein the number of available patient receiving areas is measured by comparing the number of occupied patient receiving areas and the total number of patient receiving areas.

25. The method of claim 7, wherein the number of available staff members is measured by comparing the number of staff members assigned to work with the number of staff members absent from work.

26. A health care resource scoring apparatus for a health care facility having more than one department, said apparatus comprising:
a. a digital processor for processing input data and generating output data, said processor having an input to receive input data and an output for providing output data;
b. a first source of processor input data reflecting how many patient receiving areas are available in each of plural health care departments;
c. a second source of processor input data reflecting how many staff members are available to work in each of said plural health care departments;
d. a program operating in said processor for:
i. independently for each of said plural health care departments, determining from the number of available patient receiving areas a first component of a score, with more available patient receiving areas yielding a better score,
ii. independently for each of said plural health care departments, determining from the number of available staff members a second component of a score, with more available staff members yielding a better score; and
iii. independently for each of said plural health care departments, determining a score for said health care department which is the sum of at least said first and second components; and
e. a common display for displaying output data representing the scores determined by said program for said plural health care departments.
